(19) United States
(12) Patent Application Publication
(10) Pub. No.: US 2025/0370986 A1
(43) Pub. Date: Dec. 4, 2025

(54) DATA INGESTION MANAGEMENT

(71) Applicant: Wells Fargo Bank, N.A., San Francisco, CA (US)

(72) Inventors: Jashua thejas Arul dhas, Charlotte, NC (US); Krishnakumar Chellappa, Indian Land, SC (US); Zachary Carideo, Charlotte, NC (US); Moshe Adam Van Berg, Denver, CO (US)

(21) Appl. No.: 18/678,974

(22) Filed: May 30, 2024

(51) Int. Cl. G06F 16/23; G06F 21/62

(52) U.S. Cl. CPC G06F 16/2365; G06F 21/6218

(57) ABSTRACT

An example computer system for ingestion of data can include: one or more processors; and non-transitory computer-readable storage media encoding instructions which, when executed by the one or more processors, causes the computer system to: authenticate a user to allow for definition of a configuration file for the ingestion of the data; receive the configuration file, with the configuration file defining parameters for the ingestion of the data; extract the data through an application programming interface according to the parameters of the configuration file; and perform remediation on an error record in the data according to an error code associated with the error record.

### BACKGROUND

Data increases in value, complexity, and volume as the world becomes digital. It can be a time-consuming process to manage this data, including taking significant resources to incorporate the data efficiently. For instance, data ingestion can require the proper security to manage the users who work on the data, along with customized tools to handle the data ingestion.

### SUMMARY

Examples provided herein are directed to data ingestion management.

According to one aspect, an example computer system for ingestion of data can include: one or more processors; and non-transitory computer-readable storage media encoding instructions which, when executed by the one or more processors, causes the computer system to: authenticate a user to allow for definition of a configuration file for the ingestion of the data; receive the configuration file, with the configuration file defining parameters for the ingestion of the data; extract the data through an application programming interface according to the parameters of the configuration file; and perform remediation on an error record in the data according to an error code associated with the error record.

According to another aspect, an example method for ingestion of data can include: authenticating a user to allow for definition of a configuration file for the ingestion of the data; receiving the configuration file, with the configuration file defining parameters for the ingestion of the data; extracting the data through an application programming interface according to the parameters of the configuration file; and performing remediation on an error record in the data according to an error code associated with the error record.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for data ingestion management.

FIG. 2 shows example logical components of a server device of the system of FIG. 1.

FIG. 3 shows example physical components of the server device of FIG. 2.

### DETAILED DESCRIPTION

This disclosure relates to data ingestion management.

The embodiments provided herein allow for the ingestion of data from non-traditional data sources. Examples of input files from such data sources include, without limitation, Representational State Transfer (REST) API, Management API, GraphQL, etc. The examples provided herein increase the efficiency by which such files can be ingested. The general framework that allows for these efficiencies can include one or more of: (i) authentication; (ii) preprocessing of data; (iii) application programming interface (API) data processing; (iv) postprocessing of data; and (v) failure response.

There can be various advantages associated with the technologies described herein. For instance, the concepts described herein provide for a system that is more efficient at ingesting data. The data can be ingested with less resources and greater precision, resulting in the practical application of the technology.

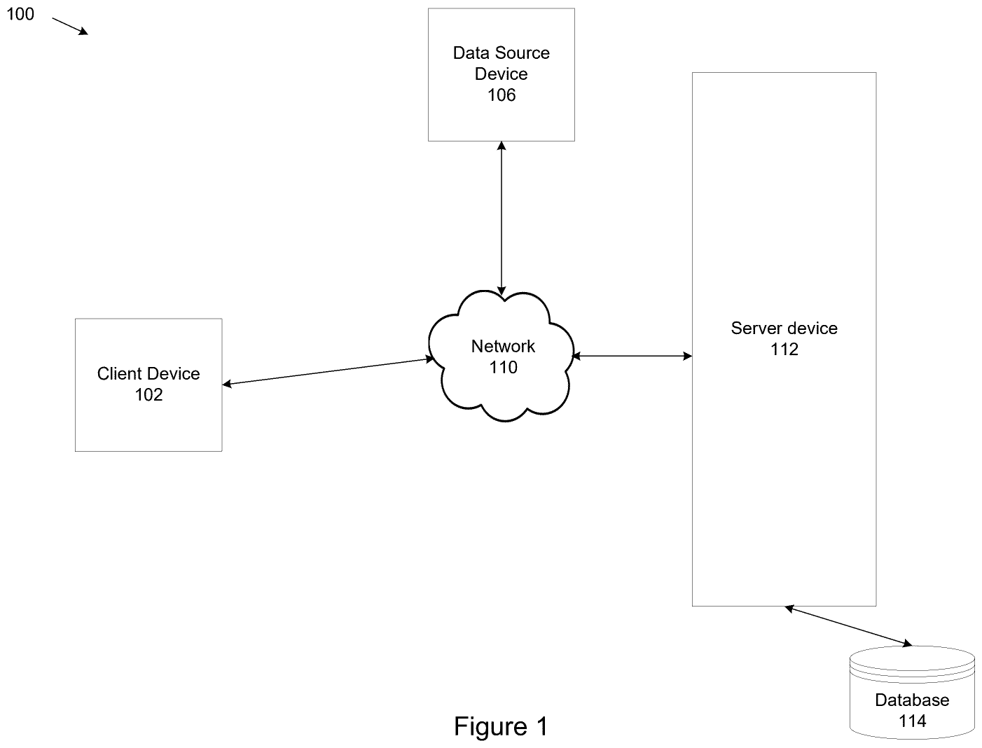

FIG. 1 schematically shows aspects of one example system 100 programmed to manage data ingestion. In this example, the system 100 can be a computing environment that includes a plurality of client and server devices. In this instance, the system 100 includes a client device 102, a data source device 106, a server device 112, and a database 114. The client device 102 and the data source device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102 can be programmed to communicate with the server device 112 to manage the ingestion of data from the data source device 106. Many other configurations are possible.

The example client device 102 is programmed to initiate and otherwise control the ingestion of data for the system 100. For instance, the client device 102 can be a computing device used by a user (e.g., developer) of the financial institution to control the ingestion of data into the system 100. This can include selection of the data, control of the data as the data is ingested, and management of any errors that occur during the ingestion.

The example data source device 106 is programmed to provide data for ingestion by the system 100. In some examples, the data source device 106 can be third party computing device that provides data to be incorporated into the system 100. In other examples, the data source device 106 can be part of the system 100 and simply provide another source of data for the system 100.

The example server device 112 is programmed to ingest the data provided by the data source device 106. As provided further below, the server device 112 can perform various functions to automate and increase the efficiency of such data ingestion.

In these examples, the server device 112 can be programmed to ingest data using various mechanisms including Representational State Transfer (REST) API. REST API is a set of architectural principles and conventions for building web services, enabling communication and interaction between different software systems over the internet. REST APIs can use HTTP methods (GET, POST, PUT, DELETE) to perform operations on resources, which are typically represented in a standardized data format like JavaScript Object Notation (JSON) or Extensible Markup Language (XML). Other mechanisms can also be used, such as Management API, GraphQL, and/or Splunk.

The example database 114 is programmed to store the data that is ingested by the server device 112. The database 114 can take various forms, such as relational databases, objected-oriented databases, and hierarchical databases. The database 114 can also take the form of a large data repository, such as a data warehouse or data lake.

The network 110 provides a wired and/or wireless connection between the client device 102, the data source device 106, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

In the examples provided, the system 100 provides end-to-end scalability, with configurable aspects for developers. As noted, these aspects can be broken into the following steps: preprocessing; processing; and postprocessing.

In the example provided here, the client device 102 provides various configuration files to initiate the ingestion of data by the server device 112. All these configuration files can be stored in a single location for execution. An example command for execution can be the following, which includes the single location (/nas/home/batch_20/prod/rif/project/) for the configuration files.

python
/nas/home/prod/rif/rif_driver.py
-d /nas/home/batch_20/prod/rif/project/
-r /nas/home/prod/rif
-u ‘date -d ″$(date +%Y−%m−1) −1 month″ +%Y%m‘

An example configuration file is used to determine the characteristics of the data ingestion. This configuration file can be provided by the client device 102 to initiate the ingestion. An example of such a configuration file follows.

```
{
  “usecase_info”: {
    “domain”: “aimd_coe”,
    “usecase”: “test”,
    “source_api”: “api_test”,
    “dest_dataset”: “dataset_test”,
    “environment”: “DEV”
  },
    “user_defined_function”: {
    “user_module”: “project_api”,
    “user_class”: “ApiProcessImpl”,
    “process_method”: “process_api”,
    “auth_method”: “auth_api”,
    “pre_process”:“Y”,
    “spark_post_process”:“Y”
  },
  “user_method_args”: {
        “auth_args”: {
      “user”: “abc”,
      “encrypted_password”: “a123”,
        “auth_url”: “https://auth/url”
        },
        “process_args”: {
        “search_url”: “https://url/1”,
        “get_url”: “https://url/2”
        },
        “pre_process_args”: { },
      “spark_post_process_args”: { }
  },
  “udf_args”: {
    “udf_col”: “column”,
    “parallelization”: 200
  },
  “data_config”: {
        “input”: {
      “path”: “/datalake/record”,
        “type”: “parquet”,
      “partition”: “Y”,
        “partition_col”: “yyyymm”,
      “partition_value”: “cur_month minus 0”
        },
      “output”: {
      “write”: “overwrite“,
      “partition”:“run_date”,
      }
  },
  “notification”: {
    “success”: “email@wellsfargo.com”,
    “failure”: “email@wellsfargo.com”
  },
  “override”: {
}
```

Aspects of this configuration file include the following.

use_case_info: usecase details and environment details

user_defined_function: user defined class and methods used therefore

user_method_args: API authentication details, process arguments, preprocess argument, post process arguments

process_args: Processing URLs and arguments requirement in API data processing

udf_args: Data passed in UDFs and number of parallel slots required for processing

data_config/input: Input file details like file format, partitioned columns, partitioned date

data_config/output: output file details like write method and output partition

notification: success and failure email notification emails

override: override parameter values for development purposes

This example configuration file defines various aspects of the ingestion. For instance, portions of the configuration file define various steps of the ingestion, such as preprocessing (pre_process”:“Y”) and postprocessing (“spark_post_process”:“Y””) flags the indicate if the optional steps of preprocessing and postprocessing are performed. In addition, aspects of parallelization of the process of ingestion are also defined at the “udf_args” section of the configuration file, which enables dynamic split and slot allocation of the input data processing, as described further below.

Further, the configuration file defines the date keys for the data to be ingested. This can include pre-defined date keys for daily and monthly format: YYYY-MM-DD or YYYYMM. This includes the input date configuration (data_config/input) and the output date configuration (data_config/output).

In response to receiving the configuration files from the client device 102, the server device 112 validates the configuration file input. For instance, the server device 112 can be programmed to confirm that fields match as a data quality check.

The server device 112 can thereupon automatically generate a dynamic schema. In this example, the schema is generated in a JSON format. A sample schema is provided below using a JSON structure, which can be complex. The schema defines all the necessary values for the data ingestion.

```
{
  “contentDataID”: “DBDB314F-6A5E”,
  “repositorySystemID”: “CORE”,
  “docID”: “{9DCxCA8-1xCE-4xx8-Bxx6-xxx1B20xxx}”,
  “contentDataDomain”: “CustomerProduct”,
  “contentDataCreateDTTM”: “9/24/2021 11:03 AM”,
  “contentDataSource”: “source”,
  “contentDataRevision”: “1”,
  “requestID”: “99999”,
  “taggedContentDataList”: [
    {
      “contentDataCollectionType”: “Entity”,
      “contentDataCollectionDescriptor”: “Person”,
      “collectionList”: [
        {
          “contentDataCollectionType”: “EntityDetail”,
          “contentDataCollectionDescriptor”: “Employee”,
          “contentDataValues”: [
            {
              “name”: “jobTitle”,
              “value”: “TEST”
            },
            {
              “name”: “fullName”,
              “value”: “TEST NAME”
            }
          ]
        },
        {
          “contentDataCollectionType”: “Address”,
          “contentDataCollectionDescriptor”: “Employer”,
          “contentDataValues”: [
            {
              “name”: “addressLine1”,
              “value”: “Test 1”
            }
          ]
        },
        {
          “contentDataCollectionType”: “PayrollDeduction”,
          “contentDataCollectionDescriptor”: “ Commission Pre-tax Deferral”,
          “contentDataValues”: [
            {
              “name”: “amountCurrentPeriod”,
              “value”: “0.00”
            }
          ]
        }
      ]
    }
  ],
  “rawContentDataList”: [
    {
    “rawContentFormat”: “text/plain”,
    “rawContentPageNumber”:“1”,
      “rawContentData”:“This is a sample lifted data”
```

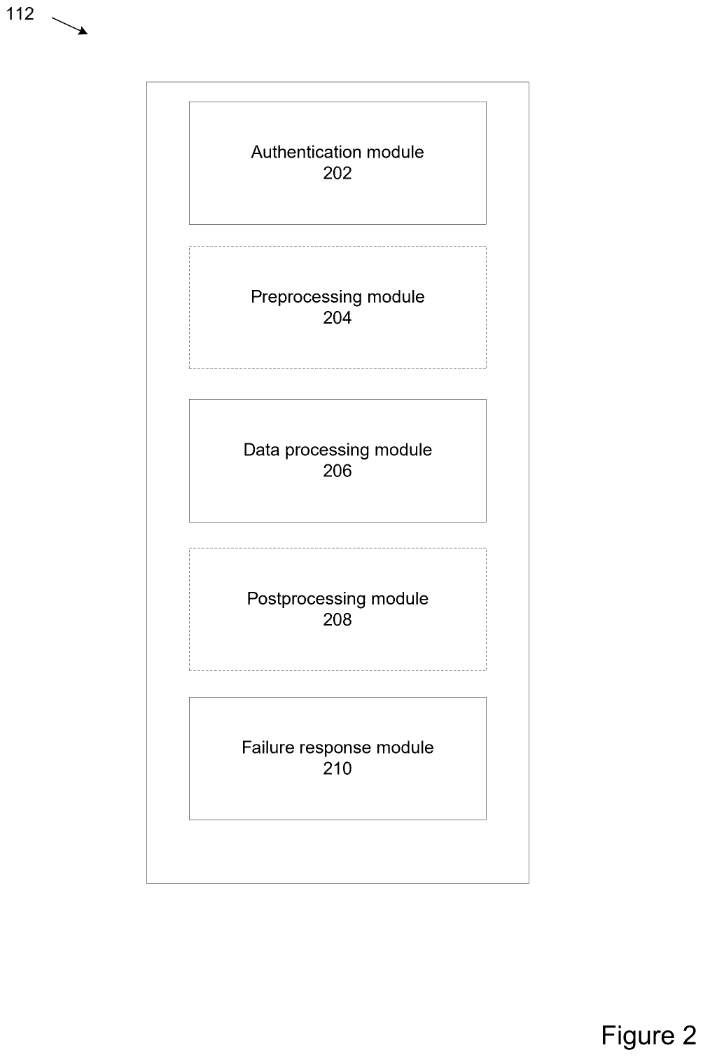

Referring now to FIG. 2, additional details of the server device 112 are shown. In this example, the server device 112 has various logical modules that assist in data ingestion. The server device 112 can, in this instance, include an authentication module 202, a preprocessing module 204, a data processing module 206, a postprocessing module 208, and a failure response module 210. In other examples, more or fewer modules providing different functionality can be used.

The example authentication module 202 is programmed to provide source authentication for one or more users of the system 100. In one embodiment, this authentication is performed through an API provided by the server device 112 for the client device 102. This API provided by the authentication module 202 generates tokens to authenticate each user, and users can develop custom code for authentication and retrieval of data by the system 100.

In this example, the authentication module 202 supports multiple authentication mechanisms with multiple API data sources within the system 100. An example Python script for authentication as executed by the authentication module 202 follows.

```
# script api_process.py
class ApiProcessImpl:
  def _{——}init_{——}(self, rif_util_path, run_date, log_path):
    sys.path.append(rif_util_path)
    from rifutils import voltage_crypt, config, log
    self.env = config.env_config( )
    self.log = log._logger(log_path, run_date)
    self.run_date = run_date
  def auth_api(self, arg_dict):
    auth_url = arg_dict.get(“auth_url”)
    # Fetch necessary parameters from the json config file
    auth_response = requests.post(auth_url, data=body, headers=header,
      verify=self.env.get(“ssl_cert”)) # sample request for reference
    return json.loads(auth_response.text).get(“access_token”)
```

This authentication module 202 can be used to authenticate the user of the client device 102 when initiating the data ingestion. Different keys providing multiple authentication mechanisms are possible. For instance, as defined in the configuration file above, the “auth_args” clause in the configuration file defines different users, passwords (encrypted), and authentication locations. Many alternatives are possible.

The example preprocessing module 204 is optionally programmed to serve as an input for API extraction data in various formats, such as comma-separated value (CSV) files, parquet files, and Hadoop Distributed File System (HDFS) files. This is an optional process which can be used depending on use case requirements. If preprocessing is not performed, data can flow directly from the data source device 106 to the data processing module 206.

The user of the client device 102 can plug-in custom code for preprocessing requirements by the preprocessing module 204. Preprocessing of data by the preprocessing module 204 can be performed prior to or in conjunction with authentication. This can include input data preprocessing and dynamic requests for Uniform Resource Locator (URL) generation for API data extraction. An example Python script for preprocessing as executed by the preprocessing module 204 follows.

```
#script name: pre_process.py
def pre_process_data(args_dict1):
  # insert your code to generate input data or transform input data
  # return the processed dataframe
  return df
```

The preprocessed data from the preprocessing module 204 serves as input for API extraction, as performed by the data processing module 206. In this example, the output of the preprocessing module 204 is provided in Spark dataframe format, although many other formats can be used.

The example data processing module 206 is programmed to perform API data extraction and processing on the data to be ingested from the data source device 106 and/or the preprocessing module 204. The data can be ingested by the data processing module 206 through a REST API utilizing JSON scripting to improve performance. Other configurations are possible.

For instance, as noted above, the data processing module 206 can perform parallelization by creating User Defined Functions (UDFs). This dynamically splits data for partitioning which reduces processing time significantly. For instance, in the example configuration file provided above, the udf_args section allows for the configuration of parallelization, including defining the column(s) and number of slots. This allows the user to increase or decrease the parallelization, thereby impacting performance.

The example optional postprocessing module 208 is programmed to perform any data transformations that are necessary after data extraction has been performed by the data processing module 206. This optional process can include flattening and/or transforming the semi-structured API data to structured data. Again, the postprocessing module 208 can use a Spark dataframe format to do so. An example Python script for postprocessing as executed by the postprocessing module 208 follows.

```
#script name: post_process.py
def post_process_api(sparkDF, args_dict1):
  # insert your code to read the data in dataframe and perform post processing
  # return the processed dataframe
  return df_processed
```

Once postprocessing is completed by the postprocessing module 208, the ingested data can be stored in a data repository, such as the database 114 or any other persistent data store, like a data lake.

The example failure response module 210 is programmed to address any missed or erroneous records that are captured during the processing. For instance, failed records can be stored in the database 114, along with error code(s) to perform specific actions to identify the reason for the error(s).

The failure response module 210 can access these records, review the error code(s), and perform attempts at remediation. Based on the type of error, the remediation can include rerunning the data through the ingestion process, modifying the data before ingestion, and/or flagging the data for manual intervention.

The failure response module 210 can set a defined number of retries, which can be configurable. For instance, the failure response module 210 can be configured to attempt remediation of a record 5 times. If the record fails after the defined number of retries, the record can be flagged for manual intervention. Further, some types of error codes require manual intervention immediately without any remediation attempts by the failure response module 210. For example, an error code of “0001” could indicate a connectivity issue that can be remediated through retries up to 5 times. However, an error code of “0005” could indicate a data corruption error that requires manual intervention. Many configurations are possible.

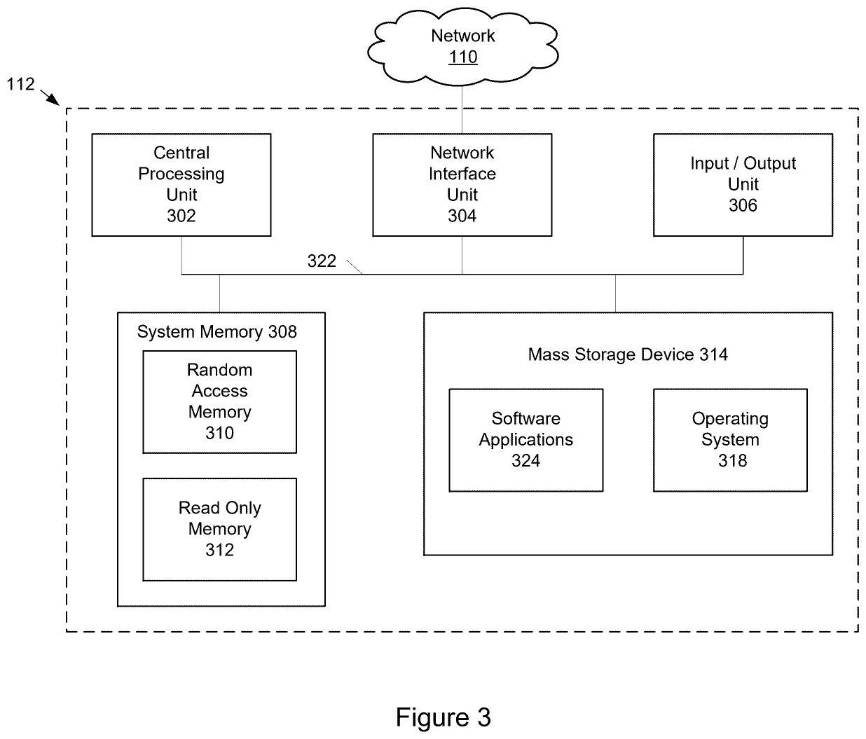

As illustrated in the embodiment of FIG. 3, the example server device 112, which provides the functionality described herein, can include at least one central processing unit (“CPU”) 302, a system memory 308, and a system bus 322 that couples the system memory 308 to the CPU 302. The system memory 308 includes a random access memory (“RAM”) 310 and a read-only memory (“ROM”) 312. A basic input/output system containing the basic routines that help transfer information between elements within the server device 112, such as during startup, is stored in the ROM 312. The server device 112 further includes a mass storage device 314. The mass storage device 314 can store software instructions and data. A central processing unit, system memory, and mass storage device similar to that shown can also be included in the other computing devices disclosed herein.

The mass storage device 314 is connected to the CPU 302 through a mass storage controller (not shown) connected to the system bus 322. The mass storage device 314 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 304 connected to the system bus 322. It should be appreciated that the network interface unit 304 may also be utilized to connect to other types of networks and remote computing systems. The server device 112 also includes an input/output controller 306 for receiving and processing input from a number of other devices, including a touch user interface display screen or another type of input device. Similarly, the input/output controller 306 may provide output to a touch user interface display screen or other output devices.

As mentioned briefly above, the mass storage device 314 and the RAM 310 of the server device 112 can store software instructions and data. The software instructions include an operating system 318 suitable for controlling the operation of the server device 112. The mass storage device 314 and/or the RAM 310 also store software instructions and applications 324, that when executed by the CPU 302, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for ingestion of data, comprising:
one or more processors; and
non-transitory computer-readable storage media encoding instructions which, when executed by the one or more processors, causes the computer system to:
authenticate a user to allow for definition of a configuration file for the ingestion of the data;
receive the configuration file, with the configuration file defining parameters for the ingestion of the data;
extract the data through an application programming interface according to the parameters of the configuration file; and
perform remediation on an error record in the data according to an error code associated with the error record.

2. The computer system of claim 1, wherein authentication of the user is configurable and includes generation of a token.

3. The computer system of claim 1, wherein the parameters of the configuration file define a number of columns and a number of slots for performing the ingestion of the data.

4. The computer system of claim 3, wherein the number of columns and the number of slots are configurable to control parallelization of extraction, processing, and the ingestion of the data.

5. The computer system of claim 1, wherein the parameters of the configuration file define a date format for the ingestion of the data.

6. The computer system of claim 1, comprising further instructions which, when executed by the one or more processors, causes the computer system to preprocess the data for the ingestion by dynamically requesting Uniform Resource Locator generation of the application programming interface for the ingestion.

7. The computer system of claim 1, comprising further instructions which, when executed by the one or more processors, causes the computer system to postprocess the data by transforming the data after the ingestion, including conversion of semi-structured data to structured data.

8. The computer system of claim 1, wherein the application programming interface for the ingestion of the data is a Representational State Transfer application programming interface.

9. The computer system of claim 1, wherein a number of tries for the remediation of the error record is configurable.

10. The computer system of claim 1, wherein the error code dictates a type of the remediation of the error record.

11. A method for ingestion of data, comprising:
authenticating a user to allow for definition of a configuration file for the ingestion of the data;
receiving the configuration file, with the configuration file defining parameters for the ingestion of the data;
extracting the data through an application programming interface according to the parameters of the configuration file; and
performing remediation on an error record in the data according to an error code associated with the error record.

12. The method of claim 11, wherein authentication of the user is configurable and includes generation of a token.

13. The method of claim 11, wherein the parameters of the configuration file define a number of columns and a number of slots for performing the ingestion of the data.

14. The method of claim 13, wherein the number of columns and the number of slots are configurable to control parallelization of extraction, processing, and the ingestion of the data.

15. The method of claim 11, wherein the parameters of the configuration file define a date format for the ingestion of the data.

16. The method of claim 11, further comprising preprocessing the data for the ingestion by dynamically requesting Uniform Resource Locator generation of the application programming interface for the ingestion.

17. The method of claim 11, further comprising postprocessing the data by transforming the data after the ingestion, including conversion of semi-structured data to structured data.

18. The method of claim 11, wherein the application programming interface for the ingestion of the data is a Representational State Transfer application programming interface.

19. The method of claim 11, wherein a number of tries for the remediation of the error record is configurable.

20. The method of claim 11, wherein the error code dictates a type of the remediation of the error record.
